(19) United States
(12) Patent Application Publication
(10) Pub. No.: US 2022/0383240 A1
(43) Pub. Date: Dec. 1, 2022

(54) MANAGING PRODUCT LIFESPAN CHANGES IN A DECENTRALIZED SUPPLY CHAIN NETWORK USING A DISTRIBUTED LEDGER DATABASE

(71) Applicant: International Business Machines Corporation, Armonk, NY (US)

(72) Inventor: SUMAN PATRA, Kolkata (IN)

(21) Appl. No.: 17/303,481

(22) Filed: May 28, 2021

(51) Int. Cl. G06Q 10/08; G06N 20/00

(52) U.S. Cl. CPC G06Q 10/087; G06N 20/00

(57) ABSTRACT

A computer maintains accountability for product lifespan changes in a decentralized supply chain network. The computer identifies a network including a distributed database operationally connected to a plurality of computers and a product being tracked with the network. The computer determines, using a Machine Learning (ML) model trained to process quality impacting values associated with a product, an initial and a second product lifespan value associated with the product, the lifespan values being based at least in part, on an initial set of quality impacting values and a second set of quality impacting values. The computer, in response to the determination, recording by the computer, the product lifespan values in the database. The computer, in response to the recording, determines a performance rating attributed to a second phase actor based, at least in part, on a calculated change in product lifespan, and recording the attribution in the database.

### BACKGROUND

The present invention relates generally to the field of computerized supply chain management, and more specifically to maintaining actor accountability within a distributed supply chain.

Sealed or packaged perishable products (e.g., raw food, certain types of medications, etc.) are often shipped with an indication of an expected product lifespan (e.g., a “Best Before” date, etc.), so that vendors and consumers can know whether it is safe to consume the product. Unfortunately, due to various conditions (e.g., overall weather encountered, exposure to humidity, nature of the product, and handling methods) present as the product travels through a supply chain to a consumer, it can be difficult for an end consumer to know whether the product is really consumable until the “Best Before” date.

Perishable products may be handled by several parties (especially in decentralized supply chain networks, where the product moves between distant actors and may experience several product handling environments) when moving from production to purchase, and “Best Before” dates can be inaccurate. For example if a product is exposed to harsh environmental conditions or has been poorly handled, it may not be safe to consume the product even within the “Best Before” date range. In those cases, the product should by discarded early to avoid endangering consumers. It can be very difficult to know how a product has been handled on the way to a consumer and whether an indicated “Best Before” date is accurate.

### SUMMARY

In embodiments according to the present invention, a computer implemented method of maintaining accountability for product lifespan changes in a decentralized supply chain network includes identifying, by a computer, a network including a distributed database operationally connected to a plurality of computers and a product being tracked with the network. The computer determines uses a Machine Learning (ML) model trained to process quality impacting values associated with a product, an initial and a second product lifespan value associated with the product, the lifespan values being based at least in part, on an initial set of quality impacting values and a second set of quality impacting values. The computer, in response to the determination, records the product lifespan values in the database. The computer, in response to the recording, determines a performance rating attributed to a second phase actor based, at least in part, on a calculated change in product lifespan, and recording the attribution in the database. According to aspects of the invention, the identification of the product being tracked is based, at least in part, on product identifying indicia included in product metadata. According to aspects of the invention, the quality impacting values are provided by at least one sensor associated with corresponding to lifespan affecting components in a supply chain network associated with the product. According to aspects of the invention, the ML model uses a data set including key, value pairs provided by the at least one sensor. According to aspects of the invention, the machine learning model is a linear regression algorithm. According to aspects of the invention, the second phase actor is penalized when the computer determines the performance rating is below a predetermined penalty threshold. According to aspects of the invention, the ML model is trained using a plurality of training data sets each associated with a correspond type, and wherein the ML model applies an algorithms, based at least in part, on a training data set associated with the identified product.

In another embodiment of the invention, a system to maintain accountability for product lifespan changes in a decentralized supply chain network includes, a computer system comprising a computer readable storage medium having program instructions embodied therewith, the program instructions executable by a computer to cause the computer to identify a network including a distributed database operationally connected to a plurality of computers and a product being tracked with the network; determine using a Machine Learning (ML) model trained to process quality impacting values associated with a product, an initial and a second product lifespan value associated with the product, the lifespan values being based at least in part, on an initial set of quality impacting values and a second set of quality impacting values; responsive to the determination, recording the product lifespan values in the database; and responsive to the recording, determining a performance rating attributed to a second phase actor based, at least in part, on a calculated change in product lifespan, and recording the attribution in the database.

In another embodiment of the invention, a computer program product to maintain accountability for product lifespan changes in a decentralized supply chain network, the computer program product comprising a computer readable storage medium having program instructions embodied therewith, the program instructions executable by a computer to cause the computer to identify, using the computer, a network including a distributed database operationally connected to a plurality of computers and a product being tracked with the network; determine, using the computer, using a Machine Learning (ML) model trained to process quality impacting values associated with a product, an initial and a second product lifespan value associated with the product, the lifespan values being based at least in part, on an initial set of quality impacting values and a second set of quality impacting values; responsive to the determination, recording, using the computer, the product lifespan values in the database; and responsive to the recording, determining, using the computer, a performance rating attributed to a second phase actor based, at least in part, on a calculated change in product lifespan, and recording the attribution in the database.

Aspects of the invention calculate and tracking a product quality value made available to all members in a decentralized supply chain network.

Aspects of the invention generate and track an actor accountability rating that reflects how much a given product supply chain actor (e.g., producer, transporter, retail handler, etc.) has negatively affected products during phases for which the actor is responsible for a given product (e.g., indicates accumulated negative impact on products). In an embodiment, the actor accountability rating is used to provide penalties (e.g., reduced transactions, fines, etc.) to actors with scores below a performance threshold.

Aspects of the invention consider phase treatment values that indicated how a given product has been treated during a given supply chain phase. In an embodiment, an overall current product quality value is based, at least in part, cumulative phase impacts on a given item. According to aspects of the invention, the overall quality value is suitable for use in reducing perishable product waste. In an embodiment, if any particular phase treatment impact value exceeds a threshold, the reputation rating of an actor responsible for the excessive impact is lowered and recorded on the shared, peer-to-peer network.

According to aspects of the invention, the product quality value for perishable products includes a dynamically-calculated best before value and is based, at least in part, on the cumulative effects of specific item treatment throughout various supply chain phases. In an embodiment, product handling sensor data captured for tracked products or product packages is used in a Machine Learning (ML) model (such as a regression algorithm trained with lifespan information for the corresponding product type) to calculate the dynamic best before date. Aspects of the invention registering product treatment data in a permissioned peer to peer network, using a decentralized database for accurate, dynamic prediction of the product best before date.

According to aspects of the invention, the dynamic best before date, actor reputation rating, product quality value, phase treatment impact values are stored on a blockchain network. In an embodiment, these values are available to participants connected to the network through Application Program Interfaces (APIs).

Aspects of the invention calculate, and make available to all the members of a supply chain network, product quality values and actor reputation ratings.

In an embodiment, aspects of the invention, a blockchain based network and decentralized databases are used together.

A novel system for registering product's treatment data in a permissioned peer to peer network, using a decentralized database for accurate prediction of best before date indicating product lifespan.

The present disclosure recognizes and addresses the shortcomings and problems associated with reliably tracking a perishable product lifespan, ensuring a product is available for safe purchase. Distributors equipped with this information in real-time can prioritize shipping and distribution of the perishable packaged items that are nearing a verified expiration date. Similarly, the retailer/wholesaler can use aspects of the present invention to offer discounts, promoting sale of packaged item nearing a confirmed end of usable life.

Additionally, aspects of the invention can keep supply chain participants accountable for jeopardizing product shelf life through improper handling.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for computer-implemented maintenance of accountability for product lifespan changes in a decentralized supply chain network optimization of input component activation in a teleconference according to embodiments of the present invention.

FIG. 2 is a flowchart illustrating a method, implemented using the system shown in FIG. 1, of maintaining accountability for product lifespan changes in a decentralized supply chain network according to aspects of the invention.

FIG. 3 is a flowchart illustrating selected aspects of a method, implemented using the system shown in FIG. 1, of maintaining accountability for product lifespan changes in a decentralized supply chain network according to aspects of the invention.

FIG. 4 is a flowchart illustrating selected aspects of a product having a lifespan tracked through various interaction phases in a decentralized supply chain network according to aspects of the invention.

FIG. 5 is a flowchart illustrating selected aspects of a product having a lifespan tracked through various interaction phases in a decentralized supply chain network according to aspects of the invention.

FIG. 6 is a flowchart illustrating selected aspects of a product having a lifespan tracked through various interaction phases in a decentralized supply chain network according to aspects of the invention.

FIG. 7 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 8 depicts a cloud computing environment according to an embodiment of the present invention.

FIG. 9 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

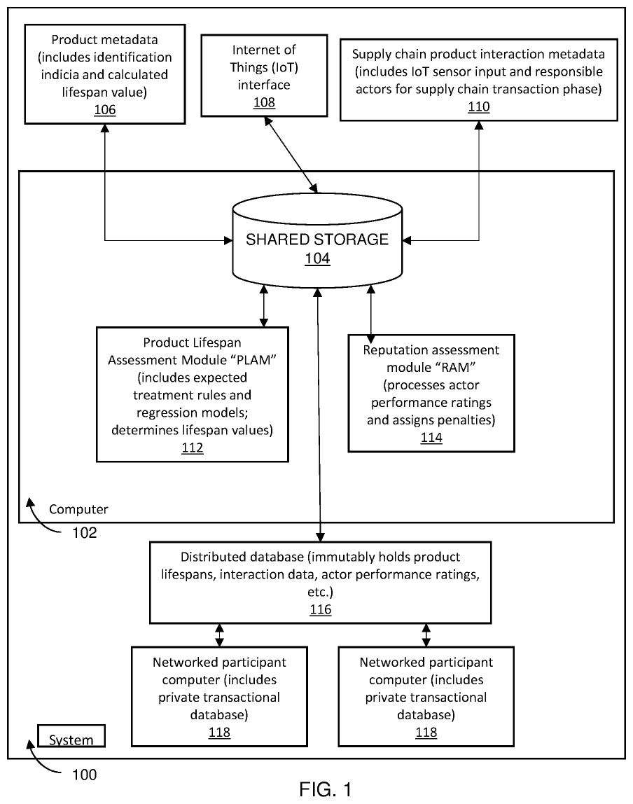

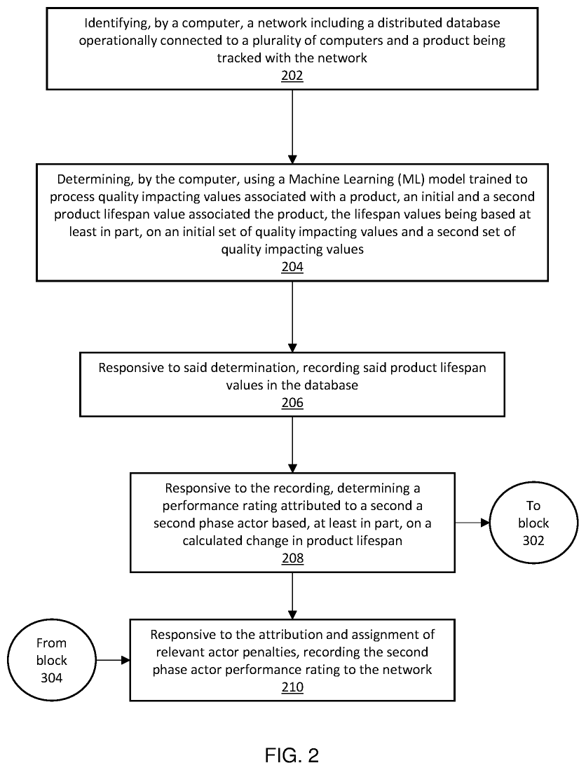

Now with combined reference to the Figures generally and with particular reference to FIG. 1 and FIG. 2, an overview of a method of maintaining accountability for product lifespan changes in a decentralized supply chain network usable within a system 100 as carried out by a server computer 102 having optionally shared storage 104 will be provided; a more detailed discussion will follow, as a method according to embodiments of the invention is described.

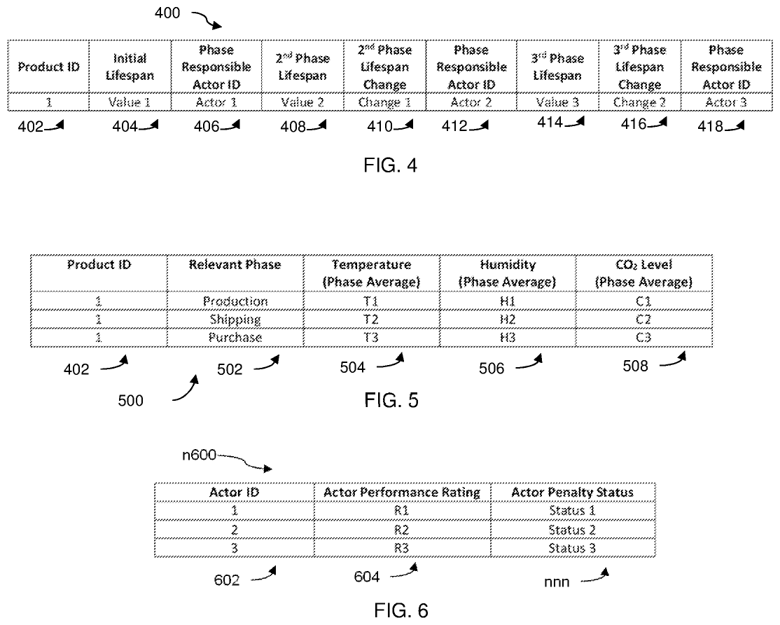

The server computer 102 is in operative communication with a source of product metadata 106. According to aspects of the invention, the metadata includes product identification indicia 402 and an initial calculated lifespan value 404 (as seen e.g., in table 400 of FIG. 4). The server computer 102 is in operative communication with an Internet of Things (IoT) interface 108, allowing IoT communication regarding tracked product interactions. The server computer 102 is in operative communication with supply chain product interaction metadata 110. According to aspects of the invention, this includes IoT sensor input 504, 506, 508 (see, e.g., table 500 in FIG. 5) and an indication of responsible actors 406, 412, 418 (e.g., product processors, product handlers, etc.) associated with for each supply chain transaction phase 502 (e.g., “Production”, “Shipping,”, and “Purchase” as seen e.g., in table 500 of FIG. 5). The server computer 102 includes a Product Lifespan Assessment Module “PLAM” 112. According to aspects of the invention, the PLAM 112 includes product treatment rules that describe expected handling metrics for various products, along with regression models used by the server computer 102 to determines product lifespan values. The server computer includes Reputation Assessment Module “RAM” 114 that, according to aspects of the invention processes actor reputation values and assigns penalties for actors with a performance rating below a penalty threshold. The server computer 102 is in operative communication with distributed database 116. According to aspects of the invention, the distributed database 116 immutably holds, among other things, product lifespans, product interaction data, and actor performance ratings. The server computer 102, via the distributed database 116 (e.g., a distributed ledger, a blockchain network, etc.) is operative communication with one or more networked computers 118. According to aspects of the invention, each networked computer 118 includes a private transactional database to capture processing data for transactions with respective peers.

Now with specific reference to FIG. 2, and to other figures generally, aspects of a method of maintaining accountability for product lifespan changes in a decentralized supply chain network will be described. The server computer 102 at block 202 identifies a network including a distributed database 116 operationally connected to a plurality of computers 118 and a source of metadata 106 associated with a product being tracked. According to aspects of the invention, a blockchain network is setup to track product “best before” date values 404, 408, 414 and handling (e.g., as seen in table 500) of perishable products as they move through the transaction phases within the supply chain.

According to aspects of the invention, each member (e.g., actor associated with phase transactions) in the supply chain involved with handling of the product is included as a participant in the network. According to aspects of the invention, an end to end, containerized system is incorporated with build the distributed network (e.g., on top of a blockchain). According to aspects of the invention, each participant must be authenticated and authorized by a network level certificate authority to gain access. The containerized system includes a front end 108 with built-in access to an internet of things (IoT) platform, a Machine Learning (ML) model (e.g., one or more product-specific regression models to predict shelf life for the modeled product type, sensor handling metadata 110, a rule engine 112 where product-specific handling rules will be stored, a distributed database system 116 that stores sensor-based product interaction metadata 110 (including e.g., handling activity location-based weather data). As noted above, each participant 118 maintains a private transactional database systems to capture processing data for transactions with respective peers.

The server computer 102, via Product Lifespan Assessment Module “PLAM” at block 204 generates data models describing a tracked products. According to aspects of the invention, the server computer models a perishable product via a blockchain smart contract as an array of key/value pair attributes that are used to store aspects of captured sensor data (as shown, e.g., in FIG. 5 such as temperature 504, humidity 506, CO₂ levels 508, etc.) at a specific location and noted point in time (e.g., a transaction phase). According to aspects of the invention, keys in this model are a composite of sensor and product container identifiers (e.g., available as part of product metadata 106). Aspects of the invention record sensor readings 504, 506, 508 (available as part of supply chain product interaction metadata 110) associated with phases (502) of product interaction, associated with product progress though the supply chain. The machine learning model 112 leverages these readings as features when computing product transaction phase-related lifespan values 408, 414 (e.g., 2^{nd} and 3^{rd} phase “best before” dates). According to aspects of the invention, the ML model applies an algorithm trained with a training data set associated with various products to be tracked.

According to aspects of the invention, products are located in matching product containers (not shown), and the containers include product identifying indicia (available as part of product metadata 106), and the server computer 102 uses this indicia when identifying a tracked product. The server computer also uses the indicia select a corresponding machine learning model and uses the corresponding model to determine a dynamic (e.g., updated during supply chain interaction) lifespan (e.g., “best before” date) for the identified product. According to aspects of the invention, the lifespan calculation is based, at least in part on collected sensor data shown in table 500. According to aspects of the invention, tracked product travel through the supply chain occurs in several distinct phases, and each phase has one or more key actors (e.g., product handlers, etc.) that interact with the product in that phase. In an embodiment, the phases include “ship”, “receive”, and “buy.” As shown FIG. 5, the phases may also include “production.”

According to aspects of the invention, the server computer 102, calculates via PLAM 112 at block 204, using a Machine Learning (ML) model trained to process quality impacting values 110, initial and second product lifespan values 404, 406, based at least in part, on an initial set T1, H1, C1 and a second set of quality impacting values T2, H2, C2 (both sets of impacting values are represented schematically in table 500).

According to aspects of the invention, the server computer 102 at block 206, in response to determining the initial and second product lifespan values, records those values in the distributed database 116. In an embodiment, a first supply chain participant 406 (e.g., a product producer) manufactures and ships an item and, as part of a “shipping” smart contract automated transaction, an initial lifespan indicating value (e.g. a “best before” date, useable life range, etc.) is calculated and propagated to the blockchain network database 116, as a first block immediately following a network-originating genesis block.

The server computer 102 determines via reputation assessment module “RAM” 114 at block 208, a performance rating attributed to a second phase actor 412 based, at least in part, on a calculated change 410 between the initial and second product lifespan calculations 404, 408. In an embodiment, the second phase participant 412 (e.g., product handler or other actor) in the network receives a container associated with the tracked product. As part of an automated “receive” smart contract transaction, a second phase best before date 408 is computed to determine whether the second lifespan 408 (e.g., product consumption window) is same as the initially-calculated lifespan 404.

According to aspects of the invention, each member of the supply chain is contractually obligated to periodically captures product handing data via sensors and forward this data 110 via an IoT Gateway 108 to be committed to blockchain through automated, smart contract transactions, and fines are levied, if a participant does not capture and commit product handling data 110 to the distributed network (e.g., blockchain) 116.

According to aspects of the invention, blockchain client APIs are used to extract the data 110 from a network 116 at each point to train the ML prediction model. Perishable item-based predictive machine learning models use this data to compute the shelf life of each product at each point of transaction in the network. Data at predetermined, phase-relevant transaction points, as well as all historical data, is taken into consideration when creating these models. Regression models are the preferred predictive models and are available for each transaction entry to dynamically predict a current product lifespan based on handling data 110 for the given product. In an embodiment, a network event monitor (not shown) notes when product sensor data 110 is committed to the blockchain 116, and the addition of data triggers an API call. According to aspects of the invention, the call reads, via PLAM 112, the available sensor collected data 110 and the PLAM 112 uses the ML model (e.g., linear regression algorithm or other method selected by one skilled in this filed) to compute product lifespan 404, 408, 414 during ship, receive and buy transactions.

It is noted that the decentralized supply chain may include many phases and additional phase actors. In an embodiment, the supply chain may include a third 418 (or more) phase-relevant actors, and a third (or further) lifespan change 416 may be present and calculated. Any reduction or lifespan reduction 410, 416 due to potential mishandling by the phase-relevant actors 406, 412, 418 will results in an update to the responsibility value 604 (as represented schematically in FIG. 6) associated with that actor and phase 502. In an embodiment, actor reputation values 604 are calculated and stored as part of the distributed network content state for the responsible actor participant as a key/value store with the key being the participant's identifier 602 and value being the updated responsibility rating 604.

The product lifespan values are product specific, and the server computer 102 via PLAM 112 stores and applies specific rules for each type of product. For example, if vendor is importing beans from a distant location, it is noted that handling data and location based weather data might be vary throughout product travels through the supply chain, and a Rule for beans will consider those factors. In an embodiment, an initial product lifespan for beans is 100. According to aspects of the invention, actor rating=(any previous phase lifespan)−(current phase lifespan)*(Rule determined phase weighting index, which ranges between 0.001 and 0.025)=previous lifespan−current responsibility rating*(0.001 to 0.025). According to aspects of the invention, when an actor participant 602 reduces 410, 416 a product lifespan, the server computer 102, via RAM 114, reduces the actor performance rating 604. The product will be eligible for consumption when the relevant phase actor 602 performance rating is >=95.

If a product is not consumable, the server computer 102 will reduce, via RAM 114, the performance rating of the actor 602 contributing most to the lifespan reduction (e.g., as indicated by lifespan changes 410, 416 or by unacceptable product handling metadata 110).

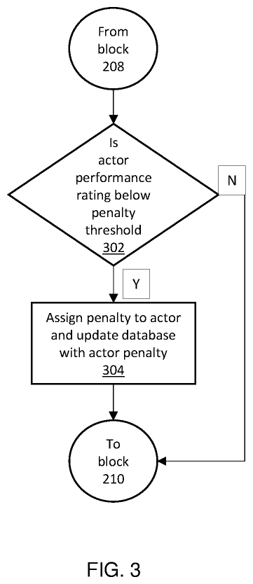

With reference to FIG. 3, the server computer 102 via Reputation Assessment Module “RAM” 114 processes actor reputation ratings and assigns penalties. According to aspects of the invention, the server computer via RAM 114 at block 302, determines, whether an actor performance rating is below penalty threshold. According to aspects of the invention, when the last block is written to the network, responsibility rating represents the penalty enforced on a participant or multiple participants in the network and accessible by all stakeholders. Repeat offenders stand to lose business for negligence in product handling. This combined with dynamic computation of best before date at every transaction phase in the network ensures the consumption viability of perishables is best preserved and accessible to all supply chain network participants. According to aspects of the invention, the performance rating 604 is a unitless quantity that indicates the cumulative product treatment trends associated with an actor generally. In an embodiment, the performance rating 604 can vary from 0 to 100, with 100 representing the best rating. If the performance rating for an actor falls below a penalty threshold of 95, the RAM 114 assigns, in block 304, a penalty to the actor in and updates the distributed database 116 accordingly. In an embodiment, the penalty may be a monetary fine, a reduction in business preference, or another tactic selected by one skilled in this field. After relevant penalties are assigned, flow returns to block 210, where the server computer 102 records the second phase actor performance rating to the network 116.

According to aspects of the invention, a transaction entered on the distributed network causes update to the previously-computed lifespan. Before any transaction block is processed and consensus reached to commit the block, smart contract/chain code is executed to compute a current lifespan (e.g., “best before” date) of the product. The updated lifespan is written to the network world state. According to aspects of the invention, incorporate smart contract business logic prevents inauthentic transactions from being propagated (e.g., committed to the network).

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

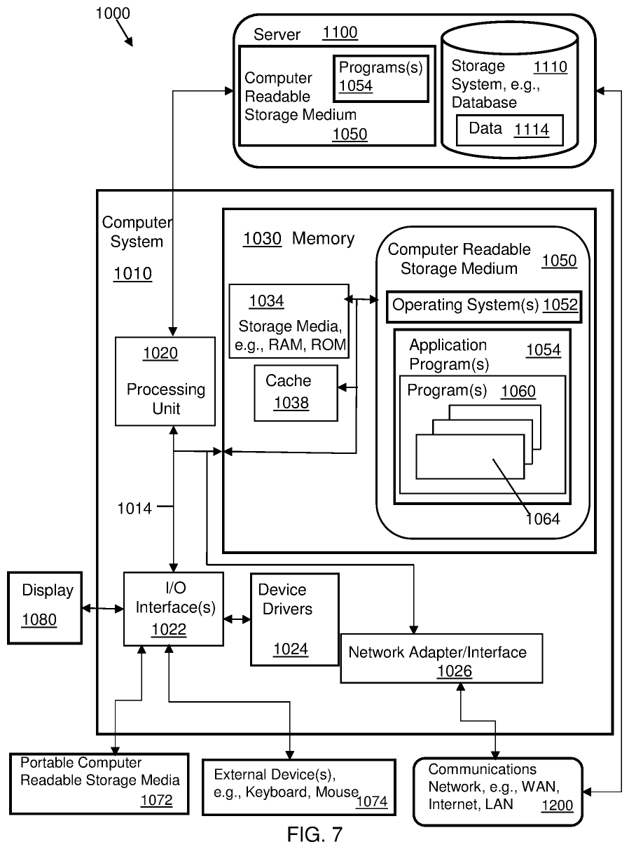

Referring to FIG. 7, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

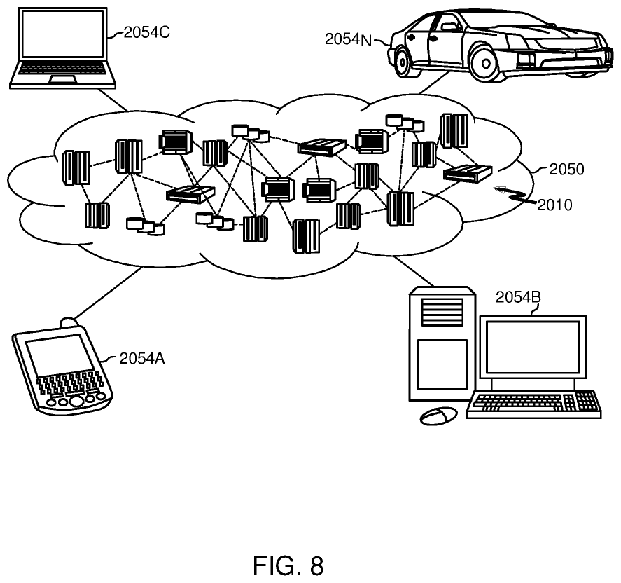

Referring now to FIG. 8, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 8 are intended to be illustrative only and that computing nodes 2010 and cloud computing environment 2050 can communicate with any type of computerized device over any type of network and/or network addressable connection (e.g., using a web browser).

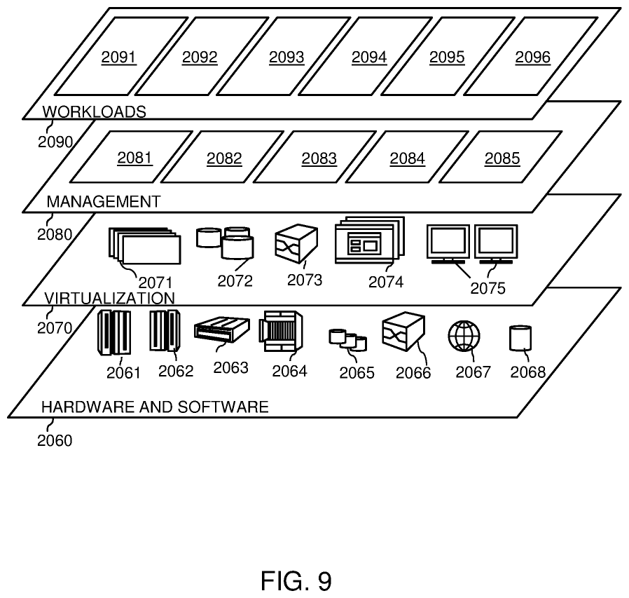

Referring now to FIG. 9, a set of functional abstraction layers provided by cloud computing environment 2050 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and maintaining accountability for product lifespan changes in a decentralized supply chain network 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer implemented method of maintaining accountability for product lifespan changes in a decentralized supply chain network, comprising:
identifying, by a computer, a network including a distributed database operationally connected to a plurality of computers and a product being tracked with the network;
determining, by the computer, using a Machine Learning (ML) model trained to process quality impacting values associated with a product, an initial and a second product lifespan value associated with the product, the lifespan values being based at least in part, on an initial set of quality impacting values and a second set of quality impacting values;
responsive to the determination, recording by the computer, the product lifespan values in the database;
responsive to the recording, determining by the computer, a performance rating attributed to a second phase actor based, at least in part, on a calculated change in product lifespan, and recording the attribution in the database;
the second actor being associated with a phase transaction in a supply chain involved with handling of the product and the second phase actor being included as a participant in the network;
generating a data model describing the product being tracked using an array of key/value pair attributes which store aspects of captured sensor data at a location and point of time indicating a phase transaction, the keys being a composite of sensor and product container identifiers being at least in part from product metadata detected and captured from the product as the product progresses though the supply chain; and
computing product transaction a phase-related lifespan value as part of the data model using the keys including the sensor and product container identifiers.

2. The method of claim 1, wherein the identification of the product being tracked is based, at least in part, on product identifying indicia included in product metadata.

3. The method of claim 1, wherein the quality impacting values are provided by at least one sensor associated with corresponding to lifespan affecting components in a supply chain network associated with the product.

4. The method of claim 3 wherein the ML model uses a data set including key, value pairs provided by the at least one sensor.

5. The method of claim 1, wherein the machine learning model is a linear regression algorithm.

6. The method of claim 1, wherein the second phase actor is penalized when the computer determines the performance rating is below a predetermined penalty threshold.

7. The method of claim 1, wherein the ML model is trained using a plurality of training data sets each associated with a corresponding type, and wherein the ML model applies an algorithm, based at least in part, on a training data set associated with the identified product.

8. system to maintain accountability for product lifespan changes in a decentralized supply chain network, which comprises:
a computer system comprising a computer readable storage medium having program instructions embodied therewith, the program instructions executable by a computer to cause the computer to:
identify a network including a distributed database operationally connected to a plurality of computers and a product being tracked with the network;
determine using a Machine Learning (ML) model trained to process quality impacting values associated with a product, an initial and a second product lifespan value associated with the product, the lifespan values being based at least in part, on an initial set of quality impacting values and a second set of quality impacting values;
responsive to the determination, recording the product lifespan values in the database;
responsive to the recording, determining a performance rating attributed to a second phase actor based, at least in part, on a calculated change in product lifespan, and recording the attribution in the database;
the second actor being associated with a phase transaction in a supply chain involved with handling of the product and the second phase actor being included as a participant in the network;
generate a data model describing the product being tracked using an array of key/value pair attributes which store aspects of captured sensor data at a location and point of time indicating a phase transaction, the keys being a composite of sensor and product container identifiers being at least in part from product metadata detected and captured from the product as the product progresses though the supply chain; and
compute product transaction a phase-related lifespan value as part of the data model using the keys including the sensor and product container identifiers.

9. The system of claim 8, wherein the identification of the product being tracked is based, at least in part, on product identifying indicia included in product metadata.

10. The system of claim 8, wherein the quality impacting values are provided by at least one sensor associated with corresponding to lifespan affecting components in a supply chain network associated with the product.

11. The system of claim 10 wherein the ML model uses a data set including key, value pairs provided by the at least one sensor.

12. The system of claim 8, wherein the machine learning model is a linear regression algorithm.

13. The system of claim 8, wherein the second phase actor is penalized when the computer determines the performance rating is below a predetermined penalty threshold.

14. The system of claim 8, wherein the ML model is trained using a plurality of training data sets each associated with a corresponding type, and wherein the ML model applies an algorithm, based at least in part, on a training data set associated with the identified product.

15. A computer program product to maintain accountability for product lifespan changes in a decentralized supply chain network, the computer program product comprising a computer readable storage medium having program instructions embodied therewith, the program instructions executable by a computer to cause the computer to:
identify, using the computer, a network including a distributed database operationally connected to a plurality of computers and a product being tracked with the network;
determine, using the computer, using a Machine Learning (ML) model trained to process quality impacting values associated with a product, an initial and a second product lifespan value associated with the product, the lifespan values being based at least in part, on an initial set of quality impacting values and a second set of quality impacting values;
responsive to the determination, recording, using the computer, the product lifespan values in the database;
responsive to the recording, determining, using the computer, a performance rating attributed to a second phase actor based, at least in part, on a calculated change in product lifespan, and recording the attribution in the database;
the second actor being associated with a phase transaction in a supply chain involved with handling of the product and the second phase actor being included as a participant in the network;
generate a data model describing the product being tracked using an array of key/value pair attributes which store aspects of captured sensor data at a location and point of time indicating a phase transaction, the keys being a composite of sensor and product container identifiers being at least in part from product metadata detected and captured from the product as the product progresses though the supply chain; and
compute product transaction a phase-related lifespan value as part of the data model using the keys including the sensor and product container identifiers.

16. The computer program product of claim 15, wherein the identification of the product being tracked is based, at least in part, on product identifying indicia included in product metadata.

17. The computer program product of claim 15, wherein the quality impacting values are provided by at least one sensor associated with corresponding to lifespan affecting components in a supply chain network associated with the product.

18. The computer program product of claim 15, wherein the machine learning model is a linear regression algorithm.

19. The computer program product of claim 15, wherein the second phase actor is penalized when the computer determines the performance rating is below a predetermined penalty threshold.

20. The computer program product of claim 15, wherein the ML model is trained using a plurality of training data sets each associated with a corresponding type, and wherein the ML model applies an algorithm, based at least in part, on a training data set associated with the identified product.
